(19) United States
(12) Patent Application Publication
(10) Pub. No.: US 2016/0279907 A1
(43) Pub. Date: Sep. 29, 2016

(54) PRINTABLE PRODUCTS AND METHODS OF MANUFACTURE THEREOF

(71) Applicant: PLASTO-SAC LTD, Sderot (IL)

(72) Inventors: Yariv SHARMI, Petach Tikva (IL); Gal SEGEV, Kibutz Maoz Haim (IL)

(73) Assignee: PLASTO-SAC LTD

(21) Appl. No.: 14/670,179

(22) Filed: Mar. 26, 2015

(51) Int. Cl. B32B 27/08; B41M 5/50

(52) U.S. Cl. CPC B32B 27/08; B41M 5/502; B32B 2307/75; B32B 2250/02; B32B 2255/00; B32B 2307/4023

(57) ABSTRACT

Disclosed are multilayer polymer products that comprise a surface suitable for printing. Disclosed are also methods for making such products and methods for printing on such products.

### FIELD OF INVENTION

The present invention relates to printable products and method of manufacture thereof.

### BACKGROUND

Plastics extrusion is a manufacturing process in which a polymer material is melted and formed into a continuous framework. Extrusion produces items such as pipes, fences, railings, window frames, plastic films and sheeting, thermoplastic coatings and wire insulation. Different techniques for extrusion are known in the art, for example blown film extrusion and cast film extrusion. Extrusion machines are known in the art, for example a blown film extrusion machine as shown in FIG. 1A.

Multi-layer extrusion is the coextrusion of multiple layers of material simultaneously to form a single product. This type of extrusion may include two or more extruders that melt the polymer resin and provide to steady throughput of different raw materials to a single die which will extrude the materials into the desired form. The layer thicknesses are controlled by the speed and size of each individual extruder, providing the resin melt. Co-extrusion allows improvement of a wide range of properties of the produced product, such as oxygen permeability, strength, stiffness, and wear-resistance.

Films and sheets produced by extrusion or coextrusion may be printable products used as printing media for flexography, rotagravure and offset printing methods. Industrial printers can print on exposed surfaces of printable products made of a wide variety of materials including surfaces of polyethylene, polypropylene, polyester, polycarbonate, but in order to optimize ink transfer and adhesion, a pre-treatment process is typically required. In some instances, pre-treatment includes applying a primer coating to a printable surface of a printable product prior to printing. A primer solution is a type of coating that may be applied to improve the into transfer and printing quality. Exemplary primer solutions that are commercially available include DigiPrime® 4431 by Michelman Inc. (Cincinnati, Ohio, USA) which is a patented flexo and gravure ready coating to provide adhesion of HP Indigo ElectroInk® to most plastic films and papers, and DigiPrime® 1000 (by Michelman Inc.) primer for digital printing that increases adhesion of Indigo inks to uncoated, mottled, semi-gloss and glossy paper grades.

In some cases, surface treatment may also be required in order to optimize the printing process. All materials have an inherent surface energy. Plastics such as polyethylene and polypropylene, are characterized by chemically inert and nonporous surfaces with low surface energy, causing them to be non-receptive to bonding with printing inks, coatings, and adhesives. Surface treatments, such as corona/plasma treatments, modify the surfaces to improve adhesion of the printed color. Corona treatment is performed by using a low temperature corona discharge to change the surface energy of the material. The corona plasma is generated by the application of high voltage to sharp electrode tips which forms plasma at the ends of the sharp tips.

The pre-printing processes such as applying a primer or coating solution to a printable product prior to printing, or performing corona treatment, are not only time-consuming but costly as well. Therefore, it is desirable to produce a printable product, to which the ink will adhere, and which does not require undergoing pre-printing preparation processes (such as priming or corona treatment) prior to printing on the printable product.

### SUMMARY OF THE INVENTION

The present invention relates to printable products, and more specifically to printable multi-layer products and a method of manufacture thereof. Specifically, some embodiments of the invention relate to printable products having an ink-receiving layer comprising ethylene copolymer.

According to an aspect of some embodiments of the invention, there is provided a printable product comprising at least two polymer layers:
an extruded ink-receiving layer comprising not less than 80% by weight of ethylene copolymer, the ink-receiving layer constituting an exposed surface of the printable product; and
directly contacting the ink-receiving layer, a core layer different from the ink-receiving layer comprising an extrudable polymer.

In some embodiments, the ink-receiving layer and the core layer are coextruded layers.

In some embodiments, the ethylene copolymer component of the ink-receiving layer comprises a single ethylene copolymer.

In some embodiments, the ethylene copolymer component of the ink-receiving layer comprises a mixture of at least two different ethylene copolymers. In some embodiments, the ethylene copolymer component of the ink-receiving layer comprises at least two different ethylene acrylic acid copolymers. In some embodiments, at least one of the ethylene acrylic acid copolymer is ethylene methacrylic acid. In some embodiments, at least one of the ethylene acrylic acid copolymer is ethylene acrylic acid, In sonic embodiments, the ethylene copolymer component of the ink-receiving layer comprises a mixture of ethylene methacrylic acid and ethylene acrylic acid.

In some embodiments, the ethylene copolymer component of the ink-receiving layer is made of not less than 0.3% and not more than 35% by weight of comonomer (e.g., an acrylic acid or acrylate comonomer).

In sonic embodiments, the extrudable polymer component comprises between 85% and 100% by weight of the core layer in some embodiments, the extendable polymer component comprises between 90% and 100% by weight of the core layer. In some embodiments, the extrudable polymer component comprises between 95% and 100% by weight of the core layer. In some embodiments, the extrudable polymer component comprises between 98% and 100% by weight of the core layer.

In some embodiments, the extrudable polymer component of the core layer is a thermoplastic polymer. In some such embodiments, the extrudable polymer component of the core layer is a thermoplastic polymer selected from the group consisting of polyethylene, polypropylene, polyester, polyethylene terephthalate, polyamide, polycarbonate, acrylonitrile-butadiene styrene, acrylic, poly methyl acrylate, polystyrene, polyvinyl chloride and combinations thereof in some such embodiments, the thermoplastic polymer component of the core layer is selected from the group consisting of an oriented thermoplastic polymer, a biaxially-oriented thermoplastic polymer, a cast thermoplastic polymer and a stretched thermoplastic polymer.

In some embodiments, a surface of the core layer is metallized.

In some embodiments, the ink-receiving layer constitutes between 0.5% and 50% of the total thickness of the printable product.

In some embodiments, the ink-receiving layer is not less than 1 micrometer thick and not more than 50 micrometers thick.

In some embodiments, the combined thickness of the ink-receiving layer and the core layer is not less than 1 micrometer and not more than 1000 micrometers thick.

In some embodiments, the combined thickness of the ink-receiving layer and the core layer being not less than 1 micrometer and not more than 40 micrometers thick.

In some embodiments, the printable product comprises at least one polymer layer in addition to the ink-receiving layer and the core layer. In some such embodiments, the additional polymer layer is a second extruded layer comprising not less than 80% by weight of ethylene copolymer directly contacting the core layer. in some such embodiments, the second extruded layer comprising not less than 80% by weight of ethylene copolymer constitutes an additional exposed surface of the printable product.

In some embodiments, the printable product further comprises a layer of print directly contacting the ink-receiving layer. In some embodiments, the layer of print covers substantially all of the ink-receiving layer, for example, a printed image, in some embodiments, the layer of print covers only a portion of the ink-receiving layer, for example, printed text where the print is characters separated by areas of ink-receiving layer not in contact with print. In some embodiments, the layer of print is selected from the group consisting of ink and toner residue. In some embodiments, the product is devoid of an intervening layer of primer residue between the layer of print and the ink-receiving, layer.

According to an aspect of some embodiments of the invention, there is also provided a method for printing on a printable product, comprising:
a. providing a printable product as described herein; and
b. printing print on the exposed surface of the printable product, that is constituted by the ink-receiving layer.

In some embodiments, the method further comprises: c. subsequent to b, applying a layer of a material on the exposed surface to cover the print. In some such embodiments, the layer of material is sufficiently transparent so that the print is visible therethrough, in some such embodiments, the layer of material is selected from the group consisting of a lacquer, a varnish and a fixative.

According to an aspect of some embodiments of the invention, there is also provided a method of manufacturing a printable product suitable for printing by coextrusion, comprising;
a. obtaining a first extrudable polymer feed comprising between 80% and 100% by weight of ethylene copolymer resin;
b. obtaining a second extrudable polymer teed comprising an extrudable polymer resin, different from the first extrudable polymer feed; and
c. in an extruder, coextruding the first polymer feed and the second polymer feed as melts to produce a multi-layer object wherein:
   a layer formed from the first polymer feed directly contacts a layer formed from the second polymer feed; and
   the layer formed from the first polymer feed constitutes an exposed surface of the multi-layer object,
      thereby manufacturing the printable product. In some embodiments, the layer formed from the first polymer feed constitute an ink-receiving layer.

In some embodiments, the ethylene copolymer resin of the first polymer feed comprises a single ethylene copolymer.

In some embodiments, the ethylene copolymer resin of the first polymer feed comprises a mixture of at least two ethylene copolymer resins.

In some embodiments, the ethylene copolymer resin of the first polymer feed is made of not less than 0.3% and not more than 35% by weight of comonomer.

In some embodiments, the second polymer feed comprises a thermoplastic polymer resin. In some embodiments, the thermoplastic polymer resin of the second polymer feed comprises a thermoplastic polymer selected from the group consisting of polyethylene, polypropylene, polyester, polyethylene terephthalate, polyamide, polycarbonate, acrylonitrile-butadiene styrene, acrylic, polystyrene, polyvinyl chloride, and combinations thereof.

In some embodiments, the method further comprises: d, subsequent to e, stretching the multi-layer object in at least one direction. In some such embodiments, the stretching of the multi-layer object is in two directions. In some such embodiments, the stretching is performed as part of a coextrusion method selected from the group consisting of blown film coextrusion, cast film coextrusion, cast sheet coextrusion and double-bubble coextrusion.

In some embodiments, the method further comprises: subsequent to c, depositing metal particles on the multi-layer object, thereby metallizing the printable product.

In some embodiments, the coextrusion is such that a layer formed from the first polymer feed constitutes between 10% and 30% of the total thickness of the multi-layer object.

In some embodiments, the method further comprises: during c, coextruding at least one additional extrudable polymer feed together with the first polymer feed and the second polymer feed as a melt, wherein a layer formed from the additional extrudable polymer feed directly contacts the layer formed from the second extrudable polymer feed. In some such embodiments, the additional polymer feed comprises between 80% and 100% by weight of ethylene copolymer resin. In some such embodiments, the layer formed from the additional polymer feed constitutes a second ink-receiving layer.

According to an aspect of some embodiments of the invention, there is also provided a printed medium comprising: a coextruded polymer medium having at least one core layer and at least one ink-receiving layer comprising at least one ethylene copolymer made by copolymerization of ethylene monomers and two or more different acrylic acid monomers where in the total amount of the acrylic acid monomers in the ethylene copolymer ranges from about 0.3% to about 35% by weight; and an ink layer disposed on the ink-receiving layer, the printing medium not including a primer or primer residue.

According to an aspect of some embodiments of the invention, there is also provided a printed medium comprising: a coextruded polymer medium having at least one core layer and at least one ink-receiving layer comprising at least one ethylene copolymer made by copolymerization of ethylene monomers and two or more different acrylic acid monomers, where in the total amount of the acrylic acid monomers in the ethylene copolymer ranges from about 0.3% to about 35% by weight; and an ink layer disposed on the ink-receiving layer, and wherein the printed medium was not subjected to a priming step before application of the ink layer to the ink-receiving layer.

According to an aspect of sonic embodiments of the invention, there is also provided a printed medium comprising; a coextruded polymer medium having at least one core layer and at least one ink-receiving layer comprising at least one ethylene copolymer made by copolymerization of a first monomer which is an ethylene monomer, at least one second monomer which is an acrylic acid monomer and at least one third monomer selected from the group consisting of a vinyl acetate, an acrylic acid, an acrylate, and a short chain alkyl acrylate, where in the total amount of the second and third monomers in the ethylene copolymer ranges from about 0.3% to about 35% by weight; and an ink layer disposed on the ink-receiving layer, the printing medium not including a primer or primer residue.

According to an aspect of some embodiments of the invention, there is also provided a printed medium comprising: as coextruded polymer medium having at least one core layer and at least one ink-receiving layer comprising at least one ethylene copolymer made by copolymerization of a first monomer which is an ethylene monomer, at least one second monomer which is an acrylic acid monomer and at least one third monomer selected from the group consisting of a vinyl acetate, an acrylic acid, an acrylate, and a short chain alkyl acrylate, where in the total amount of the second and third monomers in the ethylene copolymer ranges from about 0.3% to about 35% by weight; and an ink layer disposed on the ink-receiving layer, and wherein the printed medium was not subjected to a priming step before application of the ink layer to the ink-receiving layer.

According to an aspect of some embodiments of the invention, there is also provided a method of Liquid Electrophotographic Printing comprising the steps of: a. providing a printed medium comprising a coextruded polymer medium having at least one core layer and at least one ink-receiving layer comprising at least one ethylene copolymer made by copolymerization of a first monomer which is an ethylene monomer, at least one second monomer which is an acrylic acid monomer and at least one third monomer selected from the group consisting of a vinyl acetate, an acrylic acid, an acrylate, and a short chain alkyl acrylate, where in the total amount of the second and third monomers in the ethylene copolymer ranges from about 0.3% to about 35% by weight; and b. printing, an image on the ink-receiving layer of the medium without first priming the ink-receiving layer.

According to an aspect of some embodiments of the invention, there is also provided a printable product, comprising at least two polymer layers:
an extruded ink-receiving layer comprising not less than 80% by weight of ethylene copolymer, the ink-receiving layer constituting an exposed surface of the printable product; and
directly contacting the ink-receiving layer, a core layer different from the ink-receiving layer comprising an extrudable polymer,
further comprising a layer of print directly contacting the ink-receiving layer; and
devoid of an intervening layer of primer residue between the layer of print and the ink-receiving layer,
wherein the ethylene copolymer component of the ink-receiving layer comprises at least two different ethylene acrylic acid copolymers, and
wherein at least one the ethylene acrylic acid copolymer is ethylene acrylic acid.

In some embodiments, the ink-receiving layer and the core layer are coextruded layers.

In some embodiments, at least one the ethylene acrylic acid copolymer is ethylene methacrylic acid. In some embodiments, the ethylene copolymer component of the ink-receiving layer comprises a mixture of ethylene methacrylic acid and ethylene acrylic acid.

In some embodiments the ethylene copolymer component of the ink-receiving layer is made of not less than 0.3% and not more than 35% by weight of comonomer (monomers that are not ethylene molecules). In some embodiments, the ethylene copolymer component of the ink-receiving layer is made of not less than 1% and not more than 32% by weight of comonomer. In some embodiments, the ethylene copolymer component of the ink-receiving layer is made of not less than 2% and not more than 30% by weight of comonomer. In some embodiments, the ethylene copolymer component of the ink-receiving layer is made of not less than 5% and not more than 25% by weight of comonomer. In some embodiments, the ethylene copolymer component of the ink-receiving layer is made of not less than 10% and not more than 20% by weight of comonomer.

In some embodiments, the layer of print is selected from the group consisting of ink and toner residue.

### BRIEF DESCRIPTION OF THE DRAWINGS

Some non-limiting exemplary embodiments or features of the disclosed subject matter are illustrated in the following drawings. References to previously presented elements are implied without necessarily further citing the drawing or description in which they appear.

FIG. 1A (prior art) is a schematic illustration of a blown film extrusion machine as known in the art;

FIG. 1B (prier art) is a schematic illustration of a 3-layer die of a multi-layer co-extrusion machine as known in the art;

FIGS. 2A-2D are schematic illustrations, in cross section, of embodiments of printable products according embodiments of the disclosed subject matter, and

FIG. 3 is a flow chart of a method for manufacturing a printable product according to embodiments of the disclosed subject matter.

It will be appreciated that for simplicity and clarity of illustration, elements shown in the figures have not necessarily been drawn to scale. For example, the dimensions and/or aspect ratio of some of the elements may be exaggerated relative to other elements for clarity. Further, where considered appropriate, reference numerals may be repeated among the figures to indicate corresponding or analogous elements throughout the serial views.

### DETAILED DESCRIPTION

In the context of the present disclosure, without limiting, various aspects of the present invention will be described. For purposes of explanation, specific configurations and details are set forth in order to provide a thorough understanding of the disclosed subject matter. However, it will also be apparent to one skilled in the art that the present invention may be practiced without the specific details presented herein. Furthermore, well known features may be omitted or simplified in order not to obscure the present invention.

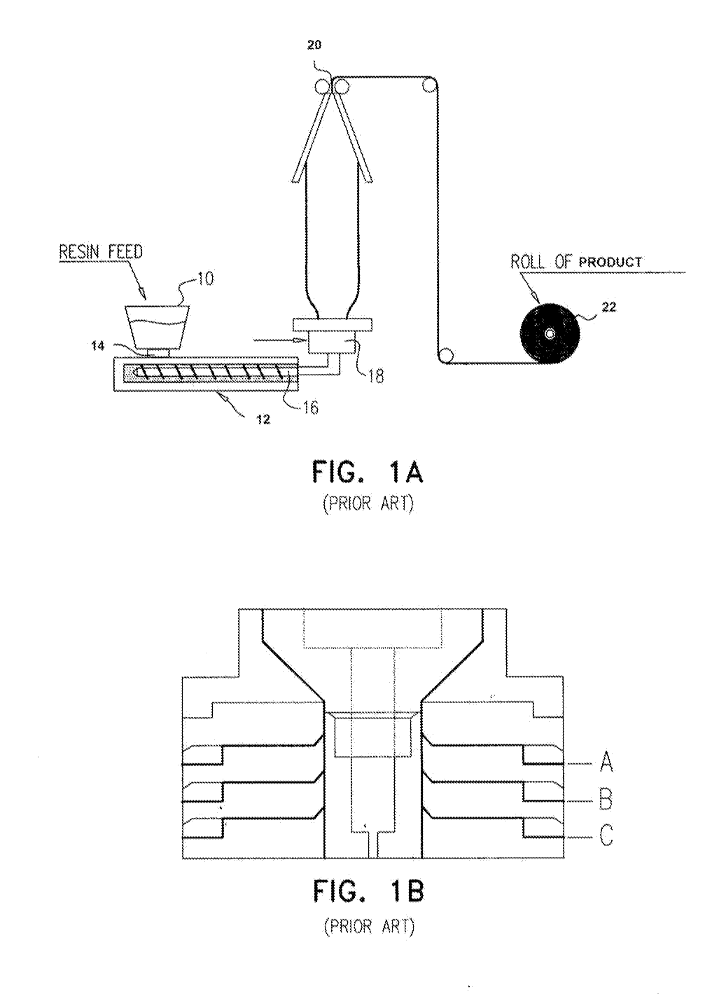

FIG. 1A illustrates a blown film extruder as known in the art that is suitable for implementing some embodiments of the teachings herein. In the extrusion, an extrudable resin of raw materials (e.g., of a polymer such as polyethylene) is fed from a feeding tank 10 into a barrel 12 of the extruder. Additives such as colorants and UV inhibitors can be mixed with the resin before charging the feeding tank 10. The resin enters the barrel 12 through the feed opening 14, and is propelled through the barrel 12 by rotating screw 16 while being heated, to eventually be forced as a melt through a die 18 which shapes the material into an extrudate. The extrudate is first air-cooled, and afterwards is pulled through a set of cooling rolls 20 to obtain a roll 22 of the product. In blown film extrusion, air cooling is performed to stretch the extrudate to obtain very thin sheets of products, and to orient the polymer crystals to increase the strength of the product.

In multi-layer blown film coextrusion, multiple layers of molten raw materials are coextruded through a common die, mutually adhering to form a multilayer product. The resin for each layer is fed through a respective feed opening of a co-extrusion machine. Multi-layer extrusion allows combining the properties of multiple extrudable materials into a single product.

FIG. 1B is a schematic illustration of a three-layer die (e.g. die 18 of FIG. 1A) of a blown film coextrusion machine as known in the art. Each of the input resins A, B and C are fed into a respective feed port of die 18 by a dedicated extruder (not depicted), and are coextruded to emerge from the exit port of the die 18 as a single multilayered product.

Another type of plastics extrusion is cast extrusion, which is typically used to extrude polymer sheet or film. Typically, cast extrusion uses, for example. T-shaped or “coat hanger” dies, which guide the flow of polymer melt from a single round output of an extruder to a thin, flat planar flow, and both die types ensure constant, uniform flow across the entire cross sectional area of the die. The cooling which is performed by pulling through a set of cooling rolls determines the sheet thickness, surface texture and crystal orientation of the final product.

It is an object of some embodiments of the present invention to provide a printable product and methods of manufacturing such a printable product which is suitable for high-quality printing and good ink adhesion, without necessarily requiring preparation processes prior to printing, such as priming and/or surface treatment such as with corona or plasma.

It is known to produce products from extrudable polymers such as thermoplastic polymers by extrusion. Known extrusion methods including blown film extrusion, cast sheet extrusion, cast film extrusion and double-bubble extrusion for manufacturing thin polymer films. Resins of polyethylene (PE), polypropylene (PP), polyethylene terephthalate (PET), polyvinyl chloride (PVC), Nylon (polyamide) and polycarbonate (PC) are thermoplastic polymers often manufactured into products using blown film extrusion and cast film extrusion.

As discussed above, some thermoplastic polymers, especially polyolefins like polyethylene and polypropylene, have low surface energy so resist interaction such as adhesion of printed ink or paint.

One option to improve adhesion of printed ink or paint to a thermoplastic polymer surface is to treat the surface to be printed by corona, plasma or flame treatment, thereby modifying the surface to increase surface energy, thereby improving adhesion of printed ink or paint. Such treatment constitutes a separate step with additional costs and complexity that may compromise the properties of thin (e.g., up to about 200 micrometer thick) products. Further, in some instances such treatments cause increased wear to machines. or cause health and safety challenges, for example, due to the generation of ozone.

An alternative to such surface treatment is application of a polymer-solvent solution known as a primer to the surface of a thermoplastic polymer to be printed, thereby producing a distinct polymer layer (typically up to 0.2 micrometer thick) to which printed ink has better adhesion. Application of primer is a separate step with additional costs that requires large volumes of solvent that is expensive, pose a significant health risk to workers, require special care and devices to prevent solvent release into the environment and extra cost associated with environmentally safe disposal. Further, two primer-treated surfaces cannot he bonded one to the other e.g., it is not practically possible to fold a primer-treated film and bond the facing primed surfaces to make a bag or balloon from the film.

Herein is disclosed the manufacture of a multi-layer product suitable for printing, having an ink-receiving layer comprising ethylene copolymer that constitutes an exposed surface of the printable product that is suitable as an ink-receiving surface, wherein the ink-receiving layer of ethylene copolymer is an extruded layer. The ink-receiving layer directly contacts an underlying core layer comprising extrudable polymer, and in some embodiments the ink-receiving layer and the core layer are coextruded layers.

It is important to note that a person having ordinary skill in the art is able, without undue effort, to ascertain whether an ink-receiving layer directly contacting a core layer comprising extrudable polymer according to the teachings herein is an extruded and/or coextruded layer (e.g., as opposed to a layer applied as a primer), for example by studying the thickness, the surface smoothness and crystalline structure of the ink-receiving layer as well as the appearance of the interface between the ink-receiving layer and the core layer with known methods, for example, electron microscopy and/or Fourier-transform infrared spectroscopy.

It has been found that, in some embodiments, the exposed surface of the ink-receiving layer according to the teachings herein is highly printable, that is to say, that it is possible to effectively print or otherwise apply toner or ink (e.g., ElectroInk® by HP Indigo) on the exposed surface, in some embodiments without necessitating physical pretreatment or application of a primer. In some embodiments, printed toner or ink are bonded fast to the exposed surface of the ink-receiving layer and are relatively resistant to removal by rubbing, abrasion or adhesion tape test.

It has been found that in some embodiments the ink-receiving layer according to the teachings herein effectively adheres to the core layer, even when the final printable product is bent, stretched and folded and that the ink-receiving layer is relatively resistant to removal from the core layer, for example, by rubbing or abrasion.

It has been found that in some embodiments, the printability of the exposed surface of the ink-receiving layer as well as the structural integrity of the ink-receiving layer and adhesion to the core layer are retained even subsequent to stretching and crystallization of the extrudable polymer making up the core layer during, blown film coextrusion, cast film coextrusion, cast sheet coextrusion and double-bubble coextrusion and even when the core layer is polyethylene terephthalate, polyvinyl chloride, or a polyolefin such as polyethylene and polypropylene.

Thus, according to an aspect of some embodiments of the teachings herein, there is provided a printable product suitable for printing comprising at least two polymer layers:
an extruded ink-receiving layer comprising not less than 80% by weight of ethylene copolymer, the ink-receiving layer constituting an exposed surface of the printable product; and
directly contacting the ink-receiving layer, a core layer different from the ink-receiving layer comprising an extrudable polymer
In some embodiments, the ink-receiving layer and the core layer are coextruded layers.

### Ink-Receiving Layer

As noted above, in some embodiments the ink-receiving layer comprises not less than 80% by weight, in some embodiments, between 80% and 100% by weight, ethylene-copolymer. In some embodiments, the ink-receiving layer comprises between 85% and 100%, between 90% and 100%, between 94% and 100%, between 96% and 100%, between 97% and 100%, between 98% and 100%, between 99% and 100%, and even between 99.5% and 100% by weight ethylene copolymer.

As used herein, the term “ethylene copolymer” relates to copolymers that result from the copolymerization of ethylene with comonomers that are selected from the group consisting of acrylic acids and acrylates.

Comonomers for implementing the teachings herein have a double bond between an alpha and a beta carbon atom. Covalently bonded to the alpha carbon is a carboxylic moiety (COOR), so that the double bond is particularly reactive. Under suitable conditions with which a person having ordinary skill in the art is familiar, such comonomers copolymerize with ethylene through the double bond, producing what are substantially polyethylene polymer molecules with pendant acid or ester functional groups.

In some embodiments, the R of the carboxylic moiety is a hydrogen so that the comonomer is an acrylic acid.

In some embodiments, the R of the carboxylic moiety is an alkyl group so that the comonomer is an acrylate. In some embodiments, the R group is an alkyl group having not more than 10 carbon atoms. In some embodiments, the R group is an alkyl group having not more than 8 carbon atoms. In some embodiments, the R group is an alkyl group having not more than 6 carbon atoms. In some embodiments, the R group is an alkyl group having not more than 4 carbon atoms. In some embodiments, the R group is an alkyl group selected from the group consisting of methyl, ethyl, propyl, n-propyl, isopropyl, butyl, n-butyl, sec-butyl, isobutyl and t-butyl

In some embodiments, the comonomer has a hydrogen bonded to the alpha carbon. In some embodiments, the comonomer has an alkyl group bonded to the alpha carbon. In some embodiments, the alkyl group bonded to the alpha carbon has not more than 10 carbon atoms. In some embodiments, the alkyl group bonded to the alpha carbon has not more than 8 carbon atoms. In some embodiments, the alkyl group bonded to the alpha carbon has not more than 6 carbon atoms. In some embodiments, the alkyl group bonded to the alpha carbon has not more than 4 carbon atoms.

Comonomers suitable for implementing the teachings herein include:
a. Comonomers having as methyl group bonded to the alpha carbon, including methacrylic acid (2-methylpropenoic acid CAS 79-41-4) and esters of methacrylic acid, such as methyl methacrylate (CAS 80-62-6), ethyl methacrylate (CAS 97-63-2), n-propyl methacrylate (CAS 2210-28-8), isopropyl methacrylate (CAS 4655-34-9) and butyl esters of methacrylic acid);
b. Comonomers having a hydrogen bonded to the alpha carbon, including acrylic acid (prop-2-enoic acid CAS 79-10-7) and esters of acrylic acid, such as methyl acrylate (CAS 96-33-3), ethyl acrylate (CAS 140-88-5), n-propyl acrylate (CAS 925-60-0), isopropyl acrylate (CAS 689-12-3) and butyl esters of acrylic acid.

In some embodiments, the ethylene copolymer component of the ink-receiving layer comprises a single ethylene copolymer, e.g., ethylene acrylic acid (EAA) (ethylene copolymerized with acrylic acid)ate or ethylene methacrylic acid (EMAA) (ethylene copolymerized with methacrylic acid).

In some embodiments the ethylene copolymer component of the ink-receiving layer comprises a mixture of at least two different ethylene copolymers. In some embodiments, the ethylene copolymer component of the ink-receiving layer comprises a mixture of ethylene acrylic acid and ethylene methacrylic acid.

In some embodiments, the ink-receiving layer comprises ethylene acrylic acid (EAA). In some such embodiments, the ink-receiving layer comprises not less than 5%, not less than 10%, not less than 5%, not less than 20%, not less than 30%, not less than 40%, not less than 50%, not less than 60%, not less than 70%, not less than 80%, not less than 90%, and even not less than 95% by weight ethylene acrylic acid. In some embodiments, the ink-receiving layer comprises ethylene acrylic acid as a sole ethylene copolymer component. In some embodiments, the ink-receiving layer consists of ethylene acrylic acid.

In some embodiments, the ink-receiving layer comprises ethylene methacrylic acid (EMAA). In some such embodiments, the ink-receiving layer comprises not less than 5%, not less than 10%, not less than 15%, not less than 20%, not less than 30%, not less than 40%, not less than 50%, not less than 60%, not less than 70%, not less than 80%, not less than 90%, and even not less than 95% by weight ethylene methactylic acid. In some embodiments, the ink-receiving layer comprises ethylene methacrylic acid (EMAA) as a sole ethylene copolymer component. In some embodiments, the ink-receiving layer consists of ethylene methacrylic acid.

In some embodiments, the ink-receiving layer comprises a mixture of ethylene acrylic acid and ethylene methacrylic acid, and in some such embodiments comprises a mixture of ethylene acrylic acid and ethylene methacrylic acid as the only ethylene copolymer components of the ink-receiving layer. In some such embodiments the weight ratio of ethylene acrylic acid to ethylene methacrylic acid of the ink-receiving layer is a ratio between 1:19 and 19:1, a ratio between 2:18 and 18:2, a ratio between 3:17 and 17:3, a ratio between 4:16 and 16:4, a ratio between 5:15 and 15:5, a ratio between 6:14 and 14:6, a ratio between 7:13 and 13:7, and even a ratio between 8:12 and 12:8.

In some embodiments, the ethylene copolymer component of the ink-receiving layer is made of not less than 0.3% and not more than 35% comonomer. In some embodiments, the ethylene copolymer component of the ink-receiving layer is made of not less than 0.4%, not less than 0.5%, not less than 1%, not less than 2%, not less than 5%, and in some embodiments not less than 10% by weight comonomer. In some embodiments, the ethylene copolymer component of the ink-receiving layer is made of not more than 32%, not more than 30%, not more than 25%, and in some embodiments not more than 20% by weight comonomer. In some embodiments, the ethylene copolymer component of the ink-receiving layer is made of not less than 5% and not more than 25% comonomer. In some embodiments, the ethylene copolymer component of the ink-receiving layer is made of not less than 10% and not more than 20% comonomer.

Ethylene copolymer suitable for implementing sonic embodiments of an ink-receiving layer according to the teachings herein are Nucrel® 31001, by DuPont™ (a copolymer of ethylene and acrylic acid (EAA) as the comonomer, where the copolymer is made of 9.5% by weight acrylic acid) and Nucrel® 925, by DuPont™ (a copolymer of ethylene and methacrylic acid (EMAA) as the comonomer, is made of 15% by weight methacrylic acid). In some embodiments, an ink-receiving layer according to the teachings herein is implemented using a combination of Nucrel® 31001 and Nucrel® 925.

In some embodiments, the ink-receiving layer comprises non-polymer components in addition to the ethylene copolymer component, for example additives such as slip (e.g., lubricants), antioxidants, UV absorbers, pigments, antistatics, inorganic materials (antiblocks) and other additives known in the art. The ink-receiving layer comprises any suitable amount of non-polymer component. In some embodiments, the ink-receiving layer comprises between 0% and 4%, between 0% and 3%, between 0% and 2%, between 0% and 1% and even between 0% and 0.5% by weight non-polymer components.

In some embodiments, the ink-receiving layer comprises in addition to the ethylene copolymer component, a thermoplastic polymer different from ethylene copolymer. in some embodiments, the ink-receiving layer comprises, in addition to the ethylene copolymer component, a thermoplastic polymer selected from the group consisting of polyethylene, polypropylene, polyester (e.g., polyethylene terephthalate), polyamide (e.g., aliphatic polyamides such as Nylon, aromatic polyamides), polycarbonate, acrylonitrile-butadiene styrene, acrylic (PMMA), poly methyl acrylate, polystyrene, polyvinyl chloride and combinations thereof. In such embodiments, the ink-receiving layer comprises any suitable amount of thermoplastic polymer different from ethylene copolymer.

In still other embodiments, the ink-receiving layer comprises an ethylene copolymer. That copolymer is made for, or contains monomers or groups including, for example, ethylene monomers and at least two acrylic acid monomers. Those acrylic acid monomers include acrylic acid, and/or short chain substituted alkylacrylic acids. Short chain in this context is an alkyl group of 1 to 6 carbons. These may include, without limitation, methacrylic acid, ethylacrylic acid (an ethyl substituted acrylic acid), propacrylic acid (a propyl substituted acrylic acid such as n-propyl acrylic acid), a butacrylic acid (a butyl substituted acrylic acid such as n-butyl acrylic acid). The total amount of the acrylic acid monomers in the ethylene copolymer can vary widely but useful ranges include from about 0.3% to about 35% by weight. In another embodiment, the range is from about 0.4% to about 32% by weight. In still another embodiment, the range is from about 0.5% to about 30% by weight. The relative proportions of the different acrylic acid species will vary with a number of factors including the desired properties of the ink-receiving layer, the type of ink to be used, and the like, and also the number and type of acrylic acid species that will be used. But, based on the use of two species, the ratio would be from about 5:1-1:5, and in another embodiment from about 3:1-to 1:3 and in still another embodiment, from about 2:1-to 1:2.

In one particular embodiment hereof, at least one of the two acrylic acid monomers is acrylic acid. Thus, in this context, the ratio of acrylic acid to a second acrylic acid monomer would be from about 5:1-1:5, and in another embodiment from about 3:1-to 1:3 and in still another embodiment, from about 2:1-to 1:2.

In another embodiment, the ink-receiving layer comprises at least one ethylene copolymer made from a first monomer which is an ethylene monomers at least one second monomer which is an acrylic acid monomer as discussed immediately above (including short chain alkyl substituted acrylic acids as mentioned above) and at least one third monomer selected from the group consisting of a vinyl acetate, an acrylic acid (different from the second monomer), an acrylate, and a short chain alkyl acrylate where short chain is as defined immediately above.

The total amount of the second and third monomers in the ethylene copolymer ranges from about 0.3% to about 35% by weight; in another embodiment, the range is from about 0.4% to about 32% by weight. In still another embodiment, the range is from about 0.5% to about 30% by weight. The relative proportions of the second monomer to the third monomer will vary with a number of factors including the desired properties of the ink-receiving layer, the type of ink to be used, and the like, and also the number and type of monomer species that will be used. But, based on the use of two species, the ratio of the second species to the third species would be from about 5:1-1:5, and in another embodiment from about 3:1-to 1:3 and in still another embodiment, from about 2:1-to 1:2.

### Core Layer

The extrudable polymer component of the core layer is any suitable extrudable polymer different from the ink-receiving layer. In some embodiments, the extrudable polymer component of the core layer is a thermoplastic polymer. The thermoplastic polymer is any suitable thermoplastic polymer. In some embodiments, the thermoplastic polymer component of the core layer comprises a polymer selected from the group consisting of polyethylene, polypropylene, polyester (e.g., polyethylene terephthalate), polyamide (e.g., aliphatic polyamides such as Nylon, aromatic polyamides), polycarbonate, acrylonitrile-butadiene styrene, acrylic (PMMA), poly methyl acrylate, polystyrene, polyvinyl chloride and combinations thereof in some preferred embodiments, the thermoplastic polymer is selected from the group consisting of polyethylene, polypropylene, polyethylene terephthalate and polyvinyl chloride.

In some embodiments, the core layer comprises additive components in additional to the polymer, for example additives such as slip (e.g., lubricants), antioxidants, UV absorbers, pigments, antistatics, inorganic materials (antiblocks) and other additives known in the art. The extrudable polymer content of the core layer is any suitable content. In some embodiments, the core layer comprises between 96% and 100%, between 97% and 100%, between 98% and 100%, between 99% and 100%, and in some embodiments between between 99.5% and 100% by weight extrudable polymer.

In some embodiments, the thermoplastic polymer component of the core layer comprises (and in some embodiments is) a polyethylene selected from the group consisting of low-density polyethylene (LDPE), linear low density polyethylene (LLDPE), medium-density polyethylene (MDPE), high-density polyethylene (HDPE) and combinations thereof.

In some embodiments, the thermoplastic polymer component of the core layer comprises (and in some embodiments is) a polypropylene selected from the group consisting of polypropylene copolymer, polypropylene random copolymer and combinations thereof.

In some embodiments, the thermoplastic polymer component of the core layer comprises (and in some embodiments is) selected from the group consisting of polyethylene terephthalate, polyvinyl chloride and combinations thereof.

In some embodiments, the thermoplastic polymer component of the core layer is selected from the group consisting of an oriented thermoplastic polymer, a biaxially-oriented thermoplastic polymer, a cast thermoplastic polymer and a stretched thermoplastic polymer, for example, made using blown film coextrusion, cast film coextrusion, cast sheet coextrusion or double-bubble coextrusion.

In some embodiments, a surface of the core layer is metallized, e.g., a metallized polyethylene terephthalate or polypropylene, for example, biaxially-oriented polyethylene terephthalate (BoPET) or oriented polypropylene. In some embodiments, metallization is performed by vapor deposition.

### Dimensions

The thickness of the ink-receiving, layer is any suitable thickness. In some embodiments, the ink-receiving layer constitutes not less than 0.5%, not less than 1%, not less than 2.5%, not less than 5% and in some embodiments not less than 15% of the total thickness of the printable product. In some embodiments, the ink-receiving layer constitutes not more than 50%, not more than 30% and in some embodiments not more than 25% of the total thickness of the printable product.

In some embodiments, the ink-receiving layer constitutes between 0.5% and 50%, 1% and 50%, 2.5% and 50%, 5% and 50% and in some embodiments between 15% and 50%, of the total thickness of the printable product.

In some embodiments, the ink-receiving layer constitutes between 0.5% and 30%, 1% and 30%, 2.5% and 30%, 5% and 30% and in some embodiments between 15% and 30% of the total thickness of the printable product. In some embodiments, the ink-receiving layer constitutes between 03% and 25%, 1% and 25%, 2.5% and 25%, 5% and 25%, and in some embodiments between 15% and 25% of the total thickness of the printable product.

In some embodiments, the ink-receiving layer is not less than 1 micrometer thick and in some embodiments not less than 2 micrometers thick. In some embodiments, the ink-receiving layer is not more than 50 micrometer thick, not more than 40 micrometers thick, not more than 30 micrometers thick, not more than 20 micrometers thick and in some embodiments not more than 8 micrometers thick.

In some embodiments, the ink-receiving layer is between 1 micrometer and 50 micrometer thick, between 1 micrometer and 40 micrometer thick, between 1 micrometer and 30 micrometer thick, between 1 micrometer and 20 micrometer thick and in some embodiments between 1 micrometer and 80 micrometer thick.

In some embodiments, the ink-receiving layer is between 2 micrometer and 50 micrometer thick, between 2 micrometer and 40 micrometer thick, between 2 micrometer and 30 micrometer thick, between 2 micrometer and 20 micrometer thick and in some embodiments between 2 micrometer and 80 micrometer thick.

The combined thickness of the ink-receiving layer and the core layer is any suitable thickness. In some embodiments, the printable product is relatively thick (e.g., a pipe or bar), so the combined thickness is relatively large and is primarily defined by the thickness of the core layer that in some embodiments is in the order of millimeters, tens of millimeters or more.

In some embodiments, the printable product is thin, in some such embodiments the combined thickness of the ink-receiving layer and the core layer being not less than 1 micrometer and not more than 1000 micrometers, not more than 800 micrometers, not more than 600 micrometers, not more than 500 micrometers, not more than 400 micrometers and in some embodiments not more than 300 micrometers thick.

In some embodiments, the printable product is exceptionally thin (e.g., a film), in some such embodiments the combined thickness of the ink-receiving layer and the core layer being not less than 1 micrometer and not more than 40 micrometer, not more than 30 micrometer and even nor more than 20 micrometer.

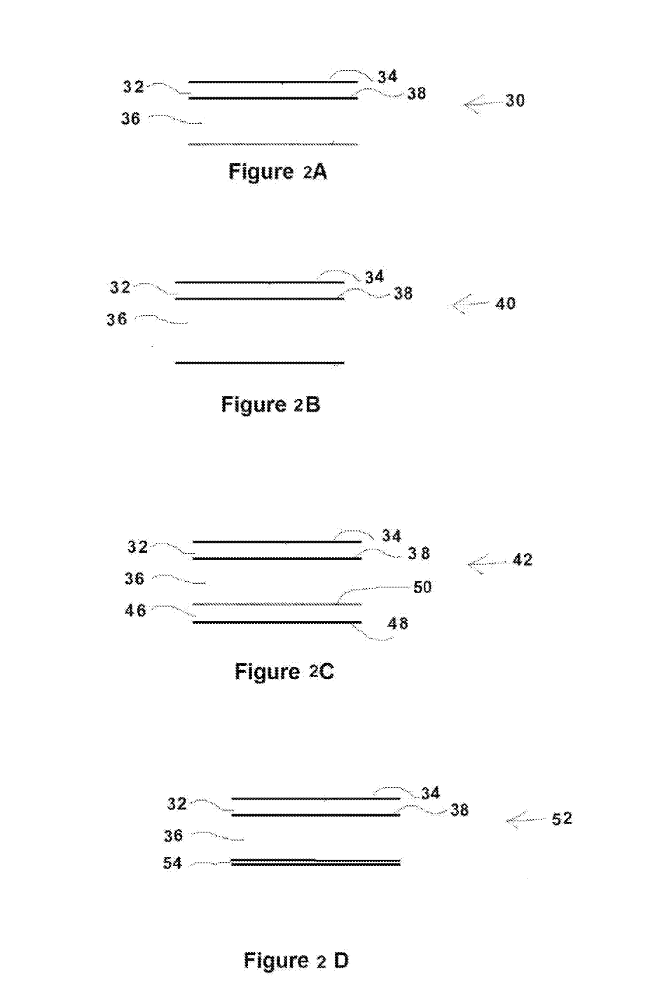

In some embodiments, the printable product comprises only the ink-receiving layer and the core layer. For example, in FIG. 2A is depicted a printable product 30 comprising an ink-receiving layer according to the teachings herein 32 comprising an exposed surface 34 and a core layer 36 (e.g., of low-density polyethylene) directly contacting ink-receiving layer 32 through interface 38, where layers 32 and 36 are coextruded layers. In FIG. 2B is depicted a printable product 40 comprising an ink-receiving layer according to the teachings herein 32 comprising an exposed surface 34 and a core layer 36 (e.g., of polyvinylchloride) directly contacting ink-receiving layer 32 through interface 38 where layers 32 and 36 are coextruded layers.

In some embodiments, the printable product comprises at least one polymer layer in addition to the ink-receiving layer and the core layer.

In some such embodiments, the additional polymer layer is a second extruded layer comprising not less than 80% by weight ethylene copolymer as described above directly contacting the core layer. In some such embodiments, the second layer constitutes a second ink-receiving layer and has an exposed surface on which can also be printed. In some embodiments, the second extruded layer comprising not less than 80% by weight ethylene copolymer as described above is a layer coextruded with the core layer and/or the ink-receiving layer. For example, in FIG. 2C is depicted a printable product 42 comprising, an ink-receiving layer according to the teachings herein 32 comprising an exposed surface 34 and a core layer 36 (e.g., of polypropylene or polyvinyl chloride) directly contacting ink-receiving layer 32 through interface 38, and further comprising an additional polymer layer 46 comprising, not less than 80% by weight ethylene copolymer comprising an exposed surface 48 directly contacting core layer 3 through an interface 50, where layers 32, 36 and 46 are coextruded layers.

As noted above, in some embodiments, the extrudable polymer core layer is metallized. In FIG. 2D is depicted a printable product 52 comprising an ink-receiving layer according to the teachings herein 32 comprising an exposed surface 34 and a core layer 36 (e.g., of polyethylene terephthalate) directly contacting. ink-receiving layer 32 through interface 38, and further metallized by a layer 54 of vapor-deposited metal particles, such as aluminum particles, where layers 32 and 36 are coextruded layers,

A printable product according to the teachings herein is any suitable object of manufacture.

In some embodiments, the printable product is a pipe, a tube, a bar, an architectural molding (coving), a structural section, a hollow structural section, a wire and a cable, on which exposed surface of the ink-receiving layer can be printed.

In some embodiments, the printable product is a film, bag or sheet, on which an exposed surface of the ink-receiving layer can be printed.

According to an aspect of some embodiments of the teachings herein, there is also provided a method for printing on an object, comprising: a. providing a printable product according to the teachings herein; and b. printing print on the exposed surface (of the ink-receiving layer) of the printable product.

As discussed above, and demonstrated in the experimental section below, typically print has good adhesion to an ink-receiving layer according to the teachings herein and there is no need to apply a surface treatment such as corona treatment to modify the surface prior to printing to ensure sufficient ink adhesion. Furthermore, in some embodiments, applying corona treatment to increase the surface tension prior to treatment may generate excessive surface tension of the ink-receiving layer of the printable product, and reduce the ink adhesion. Thus, in such embodiments, it is advantageous to manufacture the printable product and print on the exposed surface of its ink-receiving layer without applying a surface treatment such as flame, plasma or corona treatment.

That said, in some embodiments, an ink-receiving layer undergoes corona treatment prior to printing. Thus, some embodiments of methods for printing on an object according to the teachings herein further comprise: prior to b, applying corona treatment to the ink-receiving layer. By corona treatment is meant corona treatment as known in the art of plastic film manufacture, for example as implemented in commercially-available plastic film manufacturing devices.

In some embodiments, the method further comprises: c. subsequent to b, applying a layer of a material on the exposed surface to cover the print. Typically, the layer of material is sufficiently transparent so that the print is visible therethrough. In some embodiments, the layer of material is selected from the group consisting of a lacquer, a varnish and a fixative.

In some embodiments, the printing print on the exposed surface is directly printing print on the exposed surface, that is to say, the print (deposited on the exposed surface, e.g., as ink or toner) directly contacts the exposed surface with no intervening layer, e.g., of a primer. In sonic embodiments, the printing of the print is performed without prior treatment of the exposed surface with flame, plasma or corona treatment.

Any suitable printing method may be used in implementing the teachings herein. In some embodiments the printing method is selected from the group consisting of flexography, rotagravure printing and offset printing. In some embodiments, the printing is electrophotographic printing, a process that provides an image that is transferred from a photo imaging substrate either directly or indirectly via an intermediate transfer member. As such, the image is not substantially absorbed into the photo imaging substrate on which it is applied. Typically electrophotographic printing is performed using an electrophotographic printer, a printer capable of performing electrophotographic printing. In some embodiments, the electrophotographic printing is “solid electrophotographic printing” where a powder toner is printed onto the ink-receiving surface as print. In some embodiments, the electrophotographic printing is “liquid electrophotographic printing” where a liquid ink composition is printed onto the ink-receiving surface as print.

Any suitable ink or toner may be used in implementing the teachings herein. In some embodiments, the ink or toner is an ink or toner based on ethylene-acrylate copolymers or ethylene-vinyl acetate copolymer. In some embodiments, the ink is HP Indigo ElectroInk®.

A printable product according to the teachings herein is manufactured using any suitable method, for example, coextrusion.

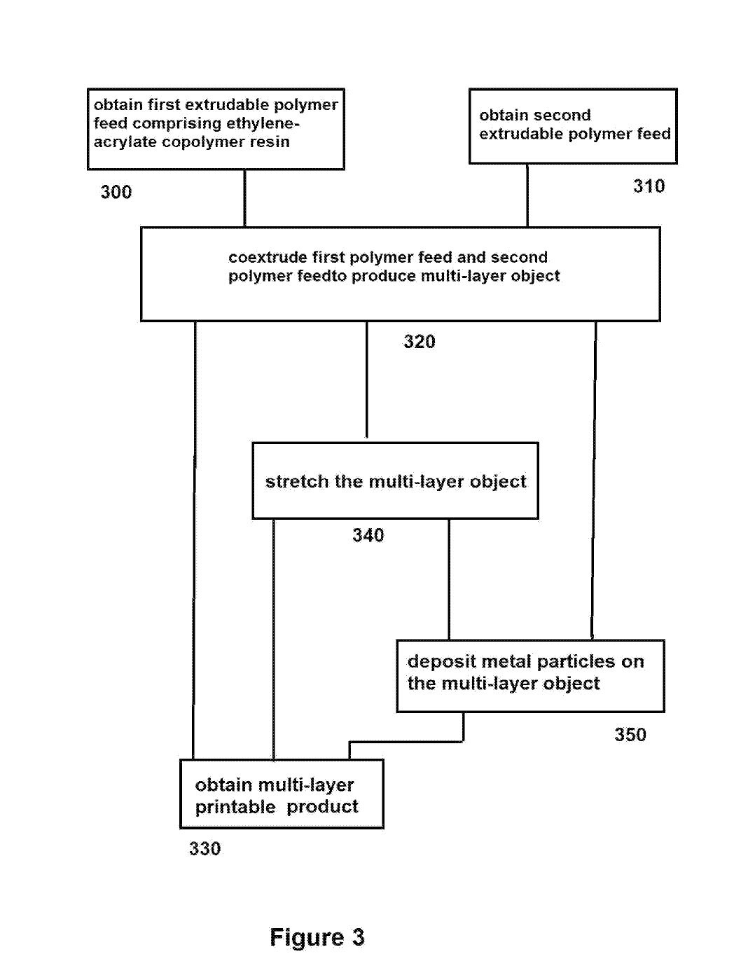

In some embodiments, a printable product according to the teachings herein is manufactured using coextrusion as is presented in detail with reference to the flow chart depicted in FIG. 3. Thus, according to an aspect of some embodiments of the teachings herein, there is also provided a method of manufacturing a printable product suitable for printing by coextrusion, comprising:
a. obtaining a first extrudable polymer feed comprising between 80% and 100% by weight of ethylene copolymer resin (300);
b. obtaining a second extrudable polymer feed comprising an extrudable polymer resin different from the first extrudable polymer feed (310); and
c. in an extruder, coextruding the first polymer feed and the second polymer feed as melts to produce a multi-layer object (320) wherein:
   a layer formed from the first polymer feed directly contacts a layer formed from the second polymer feed; and
   the layer formed from the first polymer feed constitutes an exposed surface of the multi-layer object,
      thereby manufacturing the printable product (330). In some embodiments, the printable product is as described hereinabove, where the layer formed from the first polymer feed constitutes an extruded ink-receiving layer as described hereinabove and the layer formed from the second polymer feed constitutes a core layer as described hereinabove.

In some embodiments, the coextrusion is through a single die. In some embodiments, the extruder is selected from the group consisting of a blown film coextruder, cast film coextruder, cast sheet coextruder and double-bubble coextruder.

In some embodiments, the method further comprises: during c, coextruding as a melt at least one polymer feed in addition to the first polymer feed and the second polymer feed, wherein a layer formed from the additional polymer feed directly contacts the layer formed from the second polymer feed. In some embodiments, the additional polymer feed comprises not less than 80% by weight of ethylene copolymer resin.

In some embodiments of methods for manufacturing a printable product according to the teachings herein, the first polymer feed comprises components in addition to the ethylene copolymer resin, for example non-polymer additives and/or thermoplastic polymer resins different from ethylene copolymer resin as discussed above and in amounts as discussed above with reference to the ink-receiving layer of the printable product according to the teachings herein.

In some embodiments of methods for manufacturing a printable product according to the teachings herein, the first polymer feed has a composition as discussed above with reference to the ink-receiving layer of the printable product according to the teachings herein.

In some embodiments of methods for manufacturing a printable product according to the teachings herein, the amount of comonomer of the first polymer feed is as discussed above with reference to the ink-receiving layer of the printable product according to the teachings herein.

In some embodiments of methods for manufacturing a printable product according to the teachings herein, the composition of the second polymer feed as well as the amount and presence of additives and components, is as discussed above with reference to the core layer of the printable product according to the teachings herein.

In some embodiments of methods for manufacturing a printable product according to the teachings herein, the thickness of the layer formed from the first polymer feed is as discussed above with reference to the ink-receiving layer of the printable product according to the teachings herein.

In some embodiments of methods for manufacturing a printable product according to the teachings herein, the thicknesses of the layers formed from the first polymer feed and from the second polymer feed are as discussed above with reference to the ink-receiving layer and core layer, respectively, of the printable product according to the teachings herein.

In some embodiments, methods for manufacturing a printable product according to the teachings herein further comprise: d. subsequent to c, stretching the multi-layer object in at least one direction, in some such embodiments thereby orienting the layer formed from the second polymer feed (340, 440). In some embodiments, the stretching is in one direction, in some such embodiments thereby axially orienting the layer formed from the second polymer feed so that the layer is subsequently an oriented polymer layer. In some embodiments, the stretching is in two directions, in some such embodiments thereby biaxially-orienting the layer formed from the second polymer feed so that the layer is subsequently a biaxially-oriented polymer layer.

In some embodiments, such stretching is performed as part of an extrusion method selected from the group consisting of blown film coextrusion, cast film extrusion, cast sheet coextrusion and double-bubble coextrusion.

In some embodiments, methods for manufacturing a printable product according to the teachings herein further comprise: subsequent to c, depositing metal particles on the multi-layer object, thereby metallizing the printable product (350). Typically, such depositing is on an exposed surface different from the exposed surface of the layer formed from the first polymer feed.

As discussed above, and demonstrated in the experimental section below, typically print has good adhesion to an ink-receiving layer according to the teachings herein, e.g., the exposed surface of the multi-layer object formed from the first polymer feed, and there is no need to apply a surface treatment such as corona treatment to modify the surface prior to printing to ensure sufficient ink adhesion.

That said, in some embodiments, an ink-receiving layer undergoes corona treatment prior to printing. Thus, some embodiments of methods for manufacturing a printable product according to the teachings herein further comprise: subsequent to c, applying corona treatment to the exposed surface of the layer formed from the first polymer feed. By corona treatment is meant corona treatment as known in the art of plastic film manufacture, for example as implemented in commercially-available plastic film manufacturing devices.

### Experimental

### Preparation of Printable Products According to the Teachings Herein

Nucrel® 31001, by DuPont™ (a copolymer resin of ethylene and acrylic acid (EAA) comprising 9.5% by weight comonomer) and Nucrel® 925, by DuPont™ (a copolymer resin of ethylene and methacrylic acid (EMAA) comprising 15% by weight comonomer) were obtained.

A combination of 50% by weight low-density polyethylene resin (Ipethene® 320 from Carmel Olefins Ltd., Haifa, Israel) and 50% by weight medium-density polyethylene resin (Marlex® TR 131 from Chevron Phillips Chemical Company LLC, Woodlands, Tex., USA) was obtained as an extrudable polymer resin.

A first combination of 75% by weight Nucrel® 925 and 25% by weight Nucrel® 31001 was made, providing a combined ethylene-copolymer resin having a total 13.6% by weight comonomer (11.2% methacrylic acid and 2.4% acrylic acid).

A second combination of 50% by weight Nucrel® 925 and 50% by weight Nucrel® 31001 was made, providing a combined ethylene copolymer resin having a total 12.2% by weight comonomer (7.5% methacrylic acid and 4.7% acrylic acid).

Six different embodiments of a printable products according to the teachings herein, products I, II, III, IV, V and VI were made according to the teachings herein by coextruding the obtained extrudable polyethylene resin (50% Ipethene® 320 and 50% Marlex® TR 131) with an ethylene copolymer resin.

For printable product 1, the ethylene copolymer resin was the first combination described above to combination of 75% ethylene-methacrylic acid copolymer (Nucrel® 31001), 25% ethylene-acrylic acid copolymer (Nucrel® 31001)).

For printable product II, the ethylene copolymer resin was the second combination (a combination of 50% ethylene-methacrylic acid copolymer (Nucrel® 31001), 50% ethylene-acrylic acid copolymer (Nucrel® 31001)).

For printable product III, the ethylene copolymer resin was 100% ethylene-methacrylic acid copolymer (Nucrel® 925).

For printable product IV, the ethylene copolymer resin was 100% ethylene-acrylic acid copolymer (Nucrel® 31001).

Specifically, to make each one of printable products I, II, III and IV, the obtained extrudable polyethylene resin (50% Ipethene® 320 and 50% Marlex® TR 131) and one of the selected resin of ethylene copolymer (the two combinations, Nucrel® 925, Nucrel® 31001, respectively) were coextruded in a blown-film coextruder (Varex II by Windmoeller & Hoelscher Corporation, Lincoln, R.I., USA) in accordance with the teachings herein, to manufacture the four embodiments of the printable product I, II, III and IV according to the teachings herein, in all four cases, a printable polyethylene film that had a total thickness of 80 micrometers: a 68 micrometer polyethylene core layer and a 12 micrometer ink-receiving layer. The surface energy of the ink-receiving layer of each one of the four printable products I, II, III and IV was tested and found to be 36-48 Dyne even without corona treatment.

Printable product V was made by applying corona treatment to an isolated sample of printable product I using the corona treatment module of the blown-film coextruder.

Printable product VI was made by applying corona treatment to an isolated sample of printable product H using the corona treatment module of the blown-film coextruder.

### Printing on Printable Products According to the Teachings Herein

Using a Hewlett-Packard Indigo WS6800 Digital Press, ink (HP Indigo ElectroInk®) was successfully printed on the exposed surface of the ink-receiving layers of samples of the four printable products that did not undergo corona treatment I, II, III and IV.

An attempt was made to print on the exposed surface of the ink-receiving layer of the two printable products V and VI which ink-receiving layer did undergo corona treatment, but the attempt failed due to insufficient adhesion of the ink to the corona-treated surface of the respective ink-receiving layers.

Ink adhesion to the ink-receiving layer of printable products I, II, III and IV was tested using the standard tape test with which a person having ordinary skill in the art is familiar. It was found that ink adhesion to the ink-receiving layer of printable products I and II was substantially superior to ink adhesion to the ink-receiving layer of printable products III and IV.

A reference sample was prepared by forming a 0.3 micrometer thick ink-binding layer to a surface of an 80 micrometer polyethylene film (believed to be 50% LDPE Ipethene® 320 and 50% MDPE Marlex® TR 131 as described above) by application of

DigiPrime® 1000 primer by Michelman Inc. (Cincinnati, Ohio, USA, believed to be a mixture of methacrylic acid and acrylic acid in an inert solvent), the primer applied in the usual way. Ink (HP Indigo ElectroInk®) was printed on the exposed surface of the ink-receiving layer of the reference sample in a manner identical to the described above.

Ink adhesion to the ink-receiving layer of printable products I, II and the reference sample was tested using the standard tape test with which a person having ordinary skill in the art is familiar. It was found that ink adhesion to the ink-receiving layer of printable products I and II was superior to ink adhesion to the ink-binding layer of the reference sample. This result was surprising as the ink-binding layer resulting from application of primer presumably has close to 100% coverage by acrylic acid and methacrylic acid functional groups, while the ink-receiving lavers of the two printable products I and II have approximately only 13.65% coverage or 12.2% coverage.

Samples of printable products I and II are provided to a third-party certified to evaluate printing media according to the HP Indigo “Labels & Packaging Substrate Certification Program” that evaluates a printing medium for runability, ink-transferability, blanket compatibility, blanket-temperature operating window and ink-medium interaction as reflected in degree of ink fixing to the medium, resistance of the ink layer to abrasion and degree of ink layer flaking. Both printable products receive the highest 3-star rating “Best Performing Substrates”.

### Self-Bounding of Printable Products According to the Teachings Herein

Subsequent to printing, a sample of each of printable products I and II is folded so that two ethylene copolymer layer surfaces contact The two surfaces are bonded by heating, ultrasonic welding, or with the application of a layer of acrylic adhesive. It is found that the formed bond is strong and suitable for the manufacture of bags and balloons. Equivalent tests of primer-treated polyethylene film failed to produce a strong bond.

As used herein the term configuring and/or ‘adapting’ for an objective, or a variation thereof, implies using components in a manner and/or mechanism designed for achieving the objective.

Aspects of the invention can also be understood from the following paragraphs
1. A printable product suitable for printing, comprising at least two polymer layers:
   an extruded ink-receiving layer comprising not less than 80% by weight of ethylene copolymer, said ink-receiving layer constituting an exposed surface of the printable product: and
   directly contacting said ink-receiving layer, a core layer different from said ink-receiving layer comprising an extrudable polymer.
2. The printable product of paragraph 1, wherein said ink-receiving layer and said core layer are coextruded layers.
3. The printable product of any of paragraphs 1 to 2, wherein said ethylene copolymer component of said ink-receiving layer comprises a single ethylene copolymer.
4. The printable product of any of paragraphs 1 to 3, wherein said ethylene copolymer component of said ink-receiving layer comprises a mixture of at least two different ethylene copolymers.
5. The printable product of paragraph 4, wherein said ethylene copolymer component of said ink-receiving layer comprises at least two different ethylene acrylic acid copolymers.
6. The printable product of paragraph 5, wherein at least one said ethylene acrylic acid copolymer is ethylene methacrylic acid.
7. The printable product of paragraph 5, wherein at least one said ethylene acrylic acid copolymer is ethylene acrylic acid.
8. The printable product of paragraph 5, wherein said ethylene copolymer component of said ink-receiving layer comprises a mixture of ethylene methacrylic acid and ethylene acrylic acid.
9. The printable product any of paragraphs 1 to 8, wherein said ethylene copolymer component of said ink-receiving layer is made of not less than 0.3% and not more than 35% by weight of comonomer.
10. The printable product of any of paragraphs 1 to 9, wherein said extrudable polymer component of said core layer is a thermoplastic polymer.
11. The printable product of paragraph 10, wherein said extrudable polymer component of said core layer is a thermoplastic polymer selected from the group consisting of polyethylene, polypropylene, polyester, polyethylene terephthalate, polyamide, polycarbonate, acrylonitrile-butadiene styrene, acrylic, poly methyl acrylate, polystyrene, polyvinyl chloride and combinations thereof.
12. The printable product of any of paragraphs 10 to 11, wherein said thermoplastic polymer component of said core layer is selected from the group consisting of an oriented thermoplastic polymer, a biaxially-oriented thermoplastic polymer, a cast thermoplastic polymer and a stretched thermoplastic polymer.
13. The printable product of any of paragraphs 1 to 12, wherein a surface of said core layer is metallized.
14. The printable product of any of paragraphs 1 to 13, said ink-receiving layer constituting between 0.5% and 50% of the total thickness of the printable product.
15. The printable product of any of paragraphs 1 to 14, said ink-receiving layer being not less than 1 micrometer thick and not more than 50 micrometers thick.
16. The printable product of any of paragraphs 1 to 15, the combined thickness of said ink-receiving layer and said core layer being not less than 1 micrometer and not more than 1000 micrometers thick.
17. The printable product of any of paragraphs 1 to 16, the combined thickness of said ink-receiving layer and said core layer being not less than 1 micrometer and not more than 40 micrometers thick.
18. The printable product of any of paragraphs 1 to 17, further comprising at least one polymer layer in addition to said ink-receiving layer and said core layer.
19. The printable product of paragraph 18, wherein said additional polymer layer is a second extruded layer comprising not less than 80% by weight of ethylene copolymer directly contacting said core layer.
20. The printable product of any of paragraphs 1 to 19, further comprising a layer of print directly contacting said ink-receiving layer.
21. The printable product of paragraph 20, wherein said layer of print is selected from the group consisting of ink and toner residue.
22. The printable product of any of paragraphs 20 to 21, devoid of an intervening layer of primer residue between said layer of print and said ink-receiving layer.
23. A method for printing on a printable product comprising:
   a. providing a printable product of any of paragraphs 1 to 19; and
   b. printing print on said exposed surface.
24. The method of paragraph 23, further comprising:
   c. subsequent to b, applying a layer of a material on said exposed surface to cover said print.
25. The method of paragraph 24, wherein said layer of material is sufficiently transparent so that said print is visible therethrough.
26. The method of any of paragraphs 23 to 25, wherein said layer of material is selected from the group consisting of a lacquer, a varnish and a fixative.
27. The method of any of paragraphs 23 to 26, wherein the printable product is provided without applying a surface treatment to the exposed surface.
28. A method of manufacturing a printable product suitable for printing by coextrusion, comprising:
   a. obtaining a first extrudable polymer feed comprising between 80% and 100% by weight of ethylene copolymer resin (300);
   b. obtaining a second extrudable polymer teed comprising an extrudable polymer resin, different from said first extrudable polymer teed (310); and
   c. in an extruder, coextruding said first polymer feed and said second polymer feed as melts to produce a multi-layer object (320) wherein:
      a layer formed from said first polymer feed directly contacts a layer formed from said second polymer feed: and
      said layer formed from said first polymer feed constitutes an exposed surface of said multi-layer object,
         thereby manufacturing the printable product (330).
29. The method of paragraph 28, wherein said ethylene copolymer resin of said first polymer feed comprises a single ethylene copolymer.
30. The method of paragraph 28, wherein said ethylene copolymer resin of said first polymer feed comprises a mixture of at least two ethylene copolymer resins.
31. The method of any of paragraphs 28 to 30, wherein said ethylene copolymer resin of said first polymer feed is made of not less than 0.3% and not more than 35% by weight of comonomer.
32. The method of any of paragraphs 28 to 31, wherein said second polymer feed comprises a thermoplastic polymer resin.
33. The method of paragraph 32, wherein said thermoplastic polymer resin comprises a thermoplastic polymer selected from the group consisting of polyethylene, polypropylene, polyester, polyethylene terephthalate, polyamide, polycarbonate, acrylonitrile-butadiene styrene, acrylic, polystyrene, polyvinyl chloride, and combinations thereof.
34. The method of any of paragraphs 28 to 33, further comprising:
   d. subsequent to c, stretching said multi-layer object in at least one direction.
35. The method of any of paragraphs 34, wherein said stretching of said multi-layer object is in two directions.
36. The method of any of paragraphs 34 to 35, wherein said stretching is performed as part of a coextrusion method selected from the group consisting of blown film coextrusion, cast film coextrusion, cast sheet coextrusion and double-bubble coextrusion.
37. The method of any of paragraphs 28 to 36, further comprising:
   subsequent to c, depositing metal particles on the multi-layer object thereby metallizing the printable product.
38. The method of any of paragraphs 28 to 37, wherein said coextrusion is such that a layer formed from said first polymer feed constitutes between 10% and 30% of the total thickness of the multi-layer object.
39. The method of any of paragraphs 28 to 38, further comprising:
   during c, coextruding at least one additional extrudable polymer feed together with said coextrusion of said first polymer feed and said second polymer feed as a melt, wherein a layer formed from said additional extrudable polymer feed directly contacts said layer formed from said second extrudable polymer feed.
40. The method of paragraph 39, wherein said additional polymer feed comprises between 80% and 100% by weight of ethylene copolymer resin.
41. The method of any of paragraphs 28 to 40, wherein the printable product is manufactured without applying a surface treatment to the exposed surface.
42. A printed medium comprising: a coextruded polymer medium having at least one core layer and at least one ink-receiving layer comprising at least one ethylene copolymer made by copolymerization of ethylene monomers and two or more different acrylic acid monomers, where in the total amount of said acrylic acid monomers in said ethylene copolymer ranges from about 0.3% to about 35% by weight; and an ink layer disposed on said ink-receiving layer, said printing medium not including a primer or primer residue.
43. A printed medium comprising: a coextruded polymer medium having, at least one core layer and at least one ink-receiving layer comprising at least one ethylene copolymer made by copolymerization of ethylene monomers and two or more different acrylic acid monomers, where in the total amount of said acrylic acid monomers in said ethylene copolymer ranges from about 0.3% to about 35% by weight; and an ink layer disposed on said ink-receiving layer, and wherein said printed medium was not subjected to a priming step before application of said ink layer to said ink-receiving layer.
44. A printed medium comprising: a coextruded polymer medium having at least one core layer and at least one ink-receiving layer comprising at least one ethylene copolymer made by copolymerization of a first monomer which is an ethylene monomer, at least one second monomer which is an acrylic acid monomer and at least one third monomer selected from the group consisting of a vinyl acetate, an acrylic acid, an acrylate, and a short chain alkyl acrylate, where in the total amount of said second and third monomers in said ethylene copolymer ranges from about 0.3% to about 35% by weight; and an ink layer disposed on said ink-receiving layer, said printing medium not including a primer or primer residue.
45. A printed medium comprising: a coextruded polymer medium having at least one core layer and at least one ink-receiving layer comprising at least one ethylene copolymer made by copolymerization of a first monomer which is an ethylene monomer, at least one second monomer which is an acrylic acid monomer and at least one third monomer selected from the group consisting of a vinyl acetate, an acrylic acid, an acrylate, and a short chain alkyl acrylate, where in the total amount of said second and third monomers in said ethylene copolymer ranges from about 0.3% to about 35% by weight; and an ink layer disposed on said ink-receiving layer, and wherein said printed medium was not subjected to a pruning, step before application of said ink layer to said ink-receiving layer.
46. A method of Liquid Electrophotographic Printing comprising the steps of a. providing a printed medium comprising a coextruded polymer medium having at least one core layer and at least one ink-receiving layer comprising at least one ethylene copolymer made by copolymerization of a first monomer which is an ethylene monomer, at least one second monomer which is an acrylic acid monomer and at least one third monomer selected from the group consisting of a vinyl acetate, an acrylic acid, an acrylate, and a short chain alkyl acrylate, where in the total amount of said second and third monomers in said ethylene copolymer ranges from about 0.3% to about 35% by weight; and b. printing an image on said ink-receiving layer of said medium without first priming the ink-receiving layer.
47. A printable product, comprising at least two polymer layers:
   an extruded ink-receiving layer comprising not less than 80% by weight of ethylene copolymer, said ink-receiving layer constituting an exposed surface of the printable product; and
   directly contacting said ink-receiving layer, a core layer different, from said ink-receiving layer comprising an extrudable polymer,
      further comprising a layer of print directly contacting said ink-receiving layer; and devoid of an intervening layer of primer residue between said layer of print and said ink-receiving layer,
      wherein said ethylene copolymer component of said ink-receiving layer comprises at least two different ethylene acrylic acid copolymers, and
      wherein at least one said ethylene acrylic acid copolymer is ethylene acrylic acid.
48. The printable product of paragraph 47, wherein said ink-receiving layer and said core layer are coextruded layers.
49. The printable product of any of paragraphs 47 to 48, wherein at least one said ethylene acrylic acid copolymer is ethylene methacrylic acid.
50. The printable product of any of paragraphs 47 to 49, wherein said ethylene copolymer component of said ink-receiving layer comprises a mixture of ethylene methacrylic acid and ethylene acrylic acid.
51. The printable product of any of paragraphs 47 to 50, wherein said ethylene copolymer component of said ink-receiving layer is made of not less than 0.3% and not more than 35% by weight of comonomer.
52. The printable product of any of paragraphs 47 to 50, wherein said ethylene copolymer component of said ink-receiving layer is made of not less than 1% and not more than 32% by weight of comonomer.
53. The printable product of any of paragraphs 47 to 50, wherein said ethylene copolymer component of said ink-receiving layer is made of not less than 2% and not more than 30% by weight of comonomer.
54. The printable product of any of paragraphs 47 to 50, wherein said ethylene copolymer component of said ink-receiving layer is made of not less than 5% and not more than 25% by weight of comonomer.
55. The printable product of any of paragraphs 47 to 50, wherein said ethylene copolymer component of said ink-receiving layer is made of not less than 10% and not more than 20% by weight of comonomer.
56. The printable product of any of paragraphs 47 to 55, wherein said layer of print is selected from the group consisting of ink and toner residue.

The terminology used herein should not be understood as limiting, unless otherwise specified, and is for the purpose of describing particular embodiments only and is not intended to be limiting of the disclosed subject matter. While certain embodiments of the disclosed subject matter have been illustrated and described, it will he clear that the disclosure is not limited to the embodiments described herein. Numerous modifications, changes, variations, substitutions and equivalents are not precluded.

The foregoing description of the embodiments of the invention has been presented for the purposes of illustration and description. It is not intended to be exhaustive or to limit the invention to the precise form disclosed. It should be appreciated by persons skilled in the art that many modifications, variations, substitutions, changes, and equivalents are possible in light of the above teaching. It is, therefore, to be understood that the appended claims are intended to cover all such modifications and changes as fall within the true spirit of the invention.

1. A printable product, comprising at least two polymer layers:
an extruded ink-receiving layer comprising not less than 80% by weight of ethylene copolymer, said ink-receiving layer constituting an exposed surface of the printable product; and
directly contacting said ink-receiving layer, a core layer different from said ink-receiving layer comprising an extrudable polymer,
further comprising a layer of print directly contacting said ink-receiving layer; and
devoid of an intervening layer of primer residue between said layer of print and said ink-receiving layer,
wherein said ethylene copolymer component of said ink-receiving layer comprises at least two different ethylene acrylic acid copolymers, and
wherein at least one said ethylene acrylic acid copolymer is ethylene acrylic acid.

2. The printable product of claim 1, wherein said ink-receiving layer and said core layer are coextruded layers.

3. The printable product of claim 1, wherein at least one said ethylene acrylic acid copolymer is ethylene methacrylic acid.

4. The printable product of claim 3, wherein said ethylene copolymer component of said ink-receiving layer comprises a mixture of ethylene methacrylic acid and ethylene acrylic acid.

5. The printable product of claim 1, wherein said ethylene copolymer component of said ink-receiving layer is made of not less than 0.3% and not more than 35% by weight of comonomer.

6. The printable product of claim 1, wherein said ethylene copolymer component of said ink-receiving layer is made of not less than 1% and not more than 32% by weight of comonomer.

7. The printable product of claim 1, wherein said ethylene copolymer component of said ink-receiving layer is made of not less than 2% and not more than 30% by weight of comonomer.

8. The printable product of claim 1, wherein said ethylene copolymer component of said ink-receiving layer is made of not less than 5% and not more than 25% by weight of comonomer.

9. The printable product of claim 1, wherein said ethylene copolymer component of said ink-receiving layer is made of not less than 10% and not more than 20% by weight of comonomer.

10. The printable product of claim 1, wherein said layer of print is selected from the group consisting of ink and toner residue.
